(19) United States
(12) Patent Application Publication
(10) Pub. No.: US 2011/0030236 A1
(43) Pub. Date: Feb. 10, 2011

(54) Procedure for increasing the long-term stability of transport aids

(75) Inventors: Joerg HORZEL, Alzenau (DE); Gabriele BLENDIN, Gelnhausen (DE)

Correspondence Address: DENNISON, SCHULTZ & MACDONALD, 1727 KING STREET, SUITE 105, ALEXANDRIA, VA, 22314, US

(73) Assignee: SCHOTT SOLAR AG, Mainz (DE)

(21) Appl. No.: 12/694,308

(22) Filed: Jan. 27, 2010

(30) Foreign Application Priority Data
Jan. 27, 2009 (DE) 10 2009 003 393.9

(51) Int. Cl. B01F 3/06

(52) U.S. Cl. 34/467

(57) ABSTRACT

The invention is related to a procedure for the heat treatment of semiconductor elements, which are fed through a process chamber in the continuous-flow procedure. With it, ceramic transport aids used for the transport of the semiconductor elements demonstrate a clearly better long-term mechanical stability compared with known procedures; it is proposed that at least, by way of example, one specific humid atmosphere be adjusted in the process chamber.

The invention concerns a procedure for increasing the mechanical long-term stability of transport aids, by means of which semiconductor elements are fed for heat treatment through a process chamber in the continuous-flow procedure.

To treat semiconductor elements such as, for example, silicon semiconductor elements for converting light into electrical energy, it is advantageous to carry out thermal processes at temperatures above 300° C., especially at temperatures between 700° C. and 1100° C. with process systems, which on the one hand allow a high output of semiconductor elements per unit time (typically >1500/hr, more advantageously >3000/hr) and on the other hand do not lead to any contamination, especially any metal contaminants in or on the semiconductor elements.

Continuous-flow systems are suitable for this whose transport mechanisms have no metal components at all. Corresponding thermal process systems by and large do not have any component with metallic coordination in the heated furnace interior that could come into contact in the appropriate process atmosphere.

Examples of such metal-free high-temperature continuous-flow furnaces are walking-beam furnaces, walking-filament furnaces, or furnaces with ceramic rollers as a transport mechanism for the semiconductor elements. Such furnaces are typically used for diffusion processes for semiconductor elements, especially semiconductor elements made of silicon for converting light into electrical energy.

In diffusion processes with diffusion sources of various types and chemical compositions, it is usual for volatile substances to form upon heating up the semiconductor elements and with the dopant coating located thereon, which can be precipitated onto the transport mechanisms or transport aids for the semiconductor elements or can penetrate into them. In particular, this could be phosphoric acid or polyphosphoric acids or phosphorus silicate glass precipitates in a phosphorus diffusion process, for instance, which could precipitate onto the transport aids for the semiconductor elements or penetrate into them, provided these exhibit porosity or they interact with the substances mentioned.

In the continuous operation of such a continuous-flow furnace, for the heat treatment of semiconductor elements, this can lead to the destruction of components such as ceramic filaments. Phosphorus compounds, such as those usually used in diffusion processes, can, for instance, clearly reduce the service life of ceramic filaments due to high-temperature interaction. Similarly, this holds true for the interaction of phosphorus compounds or other chemical compounds that are typically used in furnaces for the manufacture of semiconductor elements, if these interact with ceramic rollers or ceramic walking beams, for example. Thus systems are known, such as ceramic rollers driven from the outside, which project through the insulation of the furnaces straight into the heated furnace interior (process chamber). Other furnaces use ceramic beams or the previously mentioned ceramic filaments basically to feed the semiconductor elements continuously with progressive drives through the heated furnace interior. These ceramic transport aids also interact with chemical substances such as phosphorus compounds, whereby this interaction shortens the service life of these components.

In essence, part of the phosphorus compounds penetrate into ceramic transport aids such as filaments, beams, rods, or rollers and reduce the mechanical stability and strength of the components. This is particularly true if the components are subject to temperature cycles, such as occurs, for example, in heating up and cooling down the thermal systems.

Typical process atmospheres in continuous-flow process systems for the heat treatment of semiconductor elements and particularly for diffusion in semiconductor elements for converting light into electrical energy usually contain, in addition to the phosphorus compounds released, oxygen, nitrogen, or inert or noble gases such as argon. Keeping continuous-flow processes according to prior art in mind, it is considered therefrom that the atmosphere in the heated furnace interior is determined by the process gases fed in, which are humidity-free.

DE-A-10 2006 041 424 is related to a procedure for simultaneous doping and oxidation of semiconductor substrates. Here it is provided that oxidation occurs in the presence of steam, in which the thermal treatment itself can be carried out in a continuous-flow furnace, if necessary.

The object of U.S. Pat. No. 5,527,389 is a device for forming a pn-transition in solar cells. The wafer for this goes through several process chambers in which a desired air humidity prevails. Transport occurs by means of conveyor belts made of paper or fabric at temperatures of <50° C. in continuous-flow procedures.

The patent GB-A-1 314 041 provides process chambers for processing semiconductor material, in which a humid atmosphere prevails.

Walking-filament or walking-beam transport or ceramic chains are known from DE-B-103 25 602, to transport substrates continuously in temperature-controlled processing or cycled through a reaction chamber.

Ceramic filaments for transporting elements to be processed through a high-temperature zone are described in DE-B-100 59 777.

An oxidation device is known from U.S.-A-2005/0208737. Here the process gas is humidified by introducing a liquid.

A procedure for manufacturing a dielectric layer is described in U.S. Pat. No. 6,281,141.

The present invention is based on the task of improving a procedure of previously known type so that ceramic transport aids used for the transport of semiconductor elements demonstrate a clearly better long-term mechanical stability compared to known procedures. In addition, it is ensured that any metal contaminants in the transport aids for the semiconductor elements are made harmless. Furthermore, the penetration of metal contaminants into the semiconductor elements is prevented or blocked. The dopant concentration of the semiconductor elements is also controlled when doping during heat treatment.

To solve the problem, the invention in essence provides that ceramic materials are used as transport aids, which are exposed, in the process chamber open to the outside atmosphere, specifically to a humid atmosphere, in which the heat treatment in the process chamber is performed at a temperature of T≧500° C.

Differing from prior art on the basis of the teaching according to the invention, a specific humid atmosphere is produced or used in at least a portion of the process chamber, in which transport aids consisting of a ceramic material or ceramic materials run or are available.

It is in the interior of continuous-flow process systems, which are basically open to the outside atmosphere for heat treatment, particularly high-temperature treatment of semiconductor elements, which will be used in particular for converting light into electrical energy, that a specific humid atmosphere is produced.

By way of example, moisture in the heated process chamber can be fed in by pyrolysis. However, the possibility also exists of introducing, for example, a so-called “bubbled” process gas such as oxygen or nitrogen or dry compressed air, by means of a vessel, preferably heated, filled with a liquid such as water, and then feeding it into the furnace interior, and thus the process chamber. While bubbling through the liquid, the corresponding gases pick up moisture. The possibility also exists, however, of introducing steam directly into the process chamber.

Surprisingly, it has been shown that the moisture fed in acts as a protection for the ceramic transport aids that make transport possible.

The steam is condensed in the areas of the ceramic transport aids as a condensate, which is at temperatures below 100° C. in the areas of heating up and cooling down the thermal system, particularly the process chamber. If a phosphorus diffusion profile, for example, is developed in the semiconductor elements for the formation of a pn-transition on a p-conducting semiconductor substrate, phosphorus compounds are thus prevented from reaching the transport aids or, at higher concentrations, from penetrating into the ceramic components. The splitting off of water from phosphorus compounds, such as phosphoric acid or phosphorus-sol-gel dopant sources, for instance, found in contact with the semiconductor elements, which usually increases with rising process temperature, is retarded by the presence of steam in the process-space atmosphere, and thus in the process chamber, so that the diffusion source is converted to another form, as is the case in conventional processes for processing semiconductor elements.

This is especially true in the diffusion of semiconductor elements for converting light into electrical energy, which typically use phosphorus sources for economic reasons, such as phosphorus pastes, sol-gel phosphorus sources, and/or aqueous phosphoric-acid solutions, which may at any one time contain components such as a solvent and a humidifying agent.

In spite of the altered form of transformation of diffusion sources produced, in carrying out the process adapted (process-time/temperature/remaining process-gas combination), the properties of the semiconductor elements to be targeted by the processing are in no way impaired.

Also, with higher process temperatures in the process chamber, and thus in the interior of the heat-treatment furnace, an interaction comes about between the moisture introduced into the furnace interior, and thus into the process chamber, with the ceramic transport aids for transporting the semiconductor elements, as well as an interaction with the semiconductor elements themselves. Here, the moisture introduced keeps ceramic structural elements such as ceramic filaments, ceramic rollers, and/or ceramic rods, which are usually composed of Al₂O₃, SiO₂, SiC, and other high-purity ceramic materials for semiconductor processes, in a state in which no phosphorus compounds can collect on their surfaces or can penetrate into them in a harmful form.

A further effect that occurs is the following. Thus, increased moisture in the heated furnace interior here, leads to oxidation processes starting more quickly. With this, metal contaminants, provided these are in the process chamber in very small amounts, oxidizes immediately and thus makes it safe for the semiconductor elements, while otherwise, phosphorus compounds extract these metal contaminants from the ceramic surface. The rapid oxidation of all surfaces acts as protection and considerably increases the service life, in particular, of the ceramic transport aids.

Research has revealed that basically all ceramic structural elements in a humid atmosphere during high-temperature procedures also exhibit a clearly better long-term mechanical stability without the presence of phosphorus compounds or other chemical compounds in the process atmosphere. This is also true particularly when reducing process atmospheres can be avoided by means of the moisture in the furnace interior, and thus in the process chamber.

But the oxidation of semiconductor-element surfaces, such as, for instance, in the diffusion of phosphorus (P) out of previously proposed P-diffusion sources in silicon semiconductor elements for converting light into electrical energy, also offers considerable process advantages in the manufacture of these semiconductor elements:
The rapidly occurring oxidation of silicon in a humid atmosphere and an increased process temperature leads to in-situ protection of surfaces of the semiconductor elements not provided with the phosphorus source, because the comparatively thick silicon oxide layer formed keeps contamination thereof from the outside from penetrating into the semiconductor material. This protective oxide layer, which may also, in parallel, pick up contamination from the inside of the semiconductor elements, can alternatively, after completion of the heat-treatment step, be further used as a passivation layer for the semiconductor-element surfaces, like the reverse passivation of semiconductor elements for converting light into electrical energy, or can be partially or completely removed. Laser ablation procedures and/or etching procedures, such as with dilute hydrofluoric acid or hydrofluoric acid vapor, for example, are possible for this.
The oxidation of semiconductor-element surfaces clearly progresses more rapidly in a humid atmosphere, compared to dry process atmospheres. Thus, considerable oxidation rates are already occurring at temperatures below 700° C., which consequently clearly leads to a protective effect, by means of the semiconductor-oxide protective layer, earlier than in typical continuous-flow processes for the heat treatment of semiconductor elements. In typical diffusion processes for silicon, it is the case otherwise that the rates are only first considerable from 750° C. on.
The oxidation rate also increases at the boundary surface between the previously applied dopant source and the semiconductor element, at which it is first selectively or fully applied. By controlling the humidity in the process atmosphere and for the related time-temperature run in a diffusion process, the phosphorus unit-diffusion rate can be very considerably affected in contrast to prior art. While, for example, using a phosphoric acid solution as a dopant source, the dopant surface concentration in the semiconductor element can in essence only be affected by the process temperature, it is possible, based on the procedure according to the invention and the related process system, for the semiconductor material for the dopant source (preferably silicon) to considerably affect, through the oxidation rate at the boundary surface, how much dopant can penetrate into the semiconductor. The dopant concentration for an identical time-temperature profile can be affected therewith by about several orders of magnitude if the time-temperature run and the moisture feed are accordingly selected appropriately.

Independent of the type of moisture feed, a sufficient protective effect can be established for the ceramic transport aid.
By means of the higher oxidation rates at the boundary surfaces between dopant source and a semiconductor material such as, preferably, silicon, a comparatively thick SiOₓ boundary layer (semiconductor oxide) develops on the semiconductor material, which grows anew during the high-temperature treatment step. This layer can be removed in the next process step for removing the dopant source after the diffusion more easily and more residue-free than is usually the case when a sol-gel-phosphorus diffusion source is used, for instance, in which organic residues may be deposited as pyrolytic carbon onto the semiconductor material, or with diffusion sources with a very high P concentration, such as phosphoric acid solutions, for example, in which phosphorus can also be thoroughly deposited onto the semiconductor surfaces at interlattice sites. Typical post-treatment procedures such as surface treatment in hydrofluoric are not often sufficient to remove all the undesirable contaminants on the silicon surfaces.
Such contamination is already reduced or avoided from the start by oxidation in humid atmospheres.
In particular, the oxidation of semiconductor elements can alternatively be controlled so that an increased humidity is adjusted first at the ends of the transport path in the process chamber, and thus in the diffusion furnace, and it consequently results in an increased oxidation rate. It is therefore possible that an effective atmosphere differentiation is effected, through different pressure ratios in the furnace and appropriate positioning of the process-gas feed points and process-gas exhausts or appropriate cross-section reduction of the space open to the continuous flow of the semiconductor substrate. Thus, for example, in an advantageous application of the procedure, the boundary layer between a diffusion source and the underlying semiconductor-element surface can then be oxidized at an increased oxidation rate only in the rear part of a continuous-flow diffusion furnace, and there the dopant source can become impoverished, the dopant regions collected in the silicon already being transformed, so that these can be removed in subsequent process steps (hydrofluoric acid treatment, for example). This permits the combination of high diffusion rates and diffusion speeds at the beginning of the diffusion process to be built up, with the specific reduction of the surface concentration of P, as well as its targeted removal in the highly doped regions, and then contaminants deposited in oxide layers afterward. Humidity control or regulation in the previously explained procedure is generally valid and can therefore be carried out when no diffusion process takes place.

Preferably, the humid process atmosphere is, with the aid of a process gas like O₂, N₂, compressed air, or Ar as the carrier gas in the heated furnace interior of the continuous-flow furnace, therefore introduced to the process chamber for heat treatment.

Ceramic or quartz components are suitable for this, for example, which introduce the process gas as uniformly as possible over the width of the continuous-flow system to an appropriate location in the furnace. In particular, for uniform distribution of the process gases, porous ceramic plates or pipes are also suitable. With this form of gas feed, process gas can be introduced with approximately the same temperature into the furnace as its internal temperature at the corresponding location.

Advantageously, the humid process atmosphere can be fed to several locations all along the heated continuous-flow furnace for the heat treatment of semiconductor elements, like the P diffusion of silicon, for example. Preferably, between individual areas of the thermal system along the transport direction of the semiconductor elements, process-gas exhaust also occurs at suitable locations, which uniformly extracts a targeted process atmosphere in a desired volume of flow to the furnace, likewise uniformly over the width of the furnace.

Furthermore, it may be preferable, between different individual regions of the process atmospheres to perform cross-section reductions, which limit or minimize the exchange of gas atmospheres between each region. It simply needs to be ensured that the semiconductor elements can be transported further without any problem through these narrowed cross-sections.

Typical process conditions for the intended processes provide that the semiconductor elements are heated to process temperatures of 500° C. to 1150° C., preferably in the range of 800° C. to 1100° C.

In manufacturing semiconductor elements for converting light to electrical energy, it is, at the same time, preferable to limit the maximum process temperature to 920° C.

In processes of phosphorus (P) diffusion, dopant sources are used, in such cost-effective manufacturing procedures as continuous-flow procedures, which contain volatile components that escape during heat treatment.

Here, it is often preferable to use oxygen-bearing process-gas atmospheres. Acid-poor process-gas atmospheres could lead, with the removal of the volatile components of dopant sources like phosphoric acid solution (partially with organic additives) or sol-gel-P dopant sources or P pastes, to the occurrence of reducing atmospheres, which attack the ceramic components of the continuous-flow furnace, or to the disruption of the semiconductor diffusion process due to the residues remaining. It is therefore necessary to avoid such reducing conditions in the furnace atmosphere; the introduction of a humid process gas also helps here.

Typical process times in heat-treatment procedures for manufacturing semiconductor elements for converting light into electrical energy are 2 to 60 min, including the heating-up and cooling-downtimes for these processes.

The methods for manufacturing humid gas atmospheres are comparable to those already being used for closed thermal heat-treatment systems such as, for example, wet thermal oxidation in a closed quartz-tube furnace.

It is preferred to have so-called channel areas in the inlet region and/or outlet region of the furnace for quasi-continuous continuous-flow processes in open systems, which provide for gas-engineering decoupling of the process atmosphere in the furnace interior from the areas of uncontrolled atmosphere outside the furnace.

A preferred application of the invention provides for carrying out a diffusion process for driving phosphorus out of a previously applied phosphorus dopant source in a continuous-flow procedure in a so-called walking-filament furnace. By the appropriate feed of the humid process atmosphere into the heated furnace interior (process chamber), the service life of the comparatively expensive ceramic filaments and its resistance to phosphorus compounds is clearly increased at the same time, so that the running process costs can be lowered.

At the same time, it is possible to manufacture semiconductor elements with such a furnace and procedure which are preferable to prior art, because the concentration of dopant in the dopant profile can be adjusted better and also reduced by means of the oxidation occurring in a humid atmosphere. The specific semiconductor element can also be protected from contaminant atoms or can be cleaned of these. As a result, greater efficiency is possible in converting semiconductor elements from light to electrical energy.

Further details, advantages, and features of the invention result not only from the claims, from which these features may be extracted, individually and/or in combination, but also from the following description of a preferred embodiment.

Shown are:

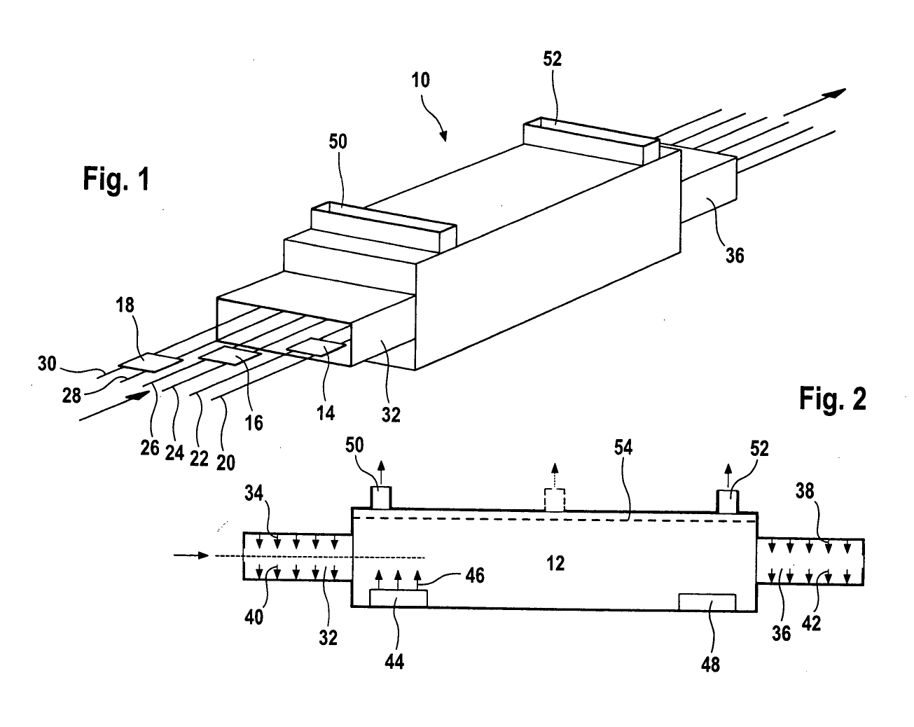

FIG. 1 a representation of the principle of a continuous-flow furnace for carrying out the procedure according to the invention, and

FIG. 2 a longitudinal section through the continuous-flow furnace according to FIG. 1, but without means of transport.

In order to process semiconductor elements without contaminants penetrating into the semiconductor elements, a continuous-flow furnace 10 is used according to the invention, which is clearly seen in principle in FIGS. 1 and 2. The continuous-flow furnace 10 exhibits a process chamber 12, in which, in the embodiment example, wafers 14, 16, 18 are passed through as semiconductor elements and undergo heat treatment at a temperature of T≧500° C. In the heat treatment, diffusion processes, for example, take place in order to feed phosphorus, for instance, from a phosphorus dopant source applied to the wafers 14, 16, 18.

With it, metal contaminants cannot penetrate into the wafers 14, 16, 18 during the heat treatment; transport aids made of ceramic materials are used. With the transport aids, ceramic filaments 20, 22; 24, 26; 28, 30, for example, of a walking-filament transport system may be involved. Al₂O₃, SiO₂, SiC, or other high-purity ceramic materials, for example, well-known in semiconductor processes are eligible as the ceramics. At the same time, selection of the ceramics is to be made such that phosphorus or boron compounds cannot collect on their surfaces.

As results from FIGS. 1 and 2, for the specific continuous-flow furnace 10, and thus for the process chamber 12, a channel 32 is proposed, into which compressed air or N₂ or O₂ or argon is introduced as a process gas (see arrow 34). The process gas will herewith produce an overpressure in the channel 32, so that the atmosphere in the process chamber 12 is not undesirably affected by outside air coming in.

In the embodiment example, a further channel 36 is inserted after the process chamber 12, in which an appropriate process gas is likewise introduced (arrow 36), which produces an overpressure relative to the process chamber 12.

The process gases are exhausted into the channels 32, 36. This is symbolized by the arrows 40, 42.

The channels 32, 36 are adjusted relative to their atmosphere such that no condensate reaches the wafers 14, 16, 18 in the process chamber 12 and in the channels 32, 26, which falls out of the atmosphere into the process chamber 12 or is precipitated onto components of the furnace 10 above the wafers 14, 16, 18 and could drop onto the wafers 14, 16, 18. The channel 32 or 36 basically produces a targeted gas flow for adjusting the desired atmosphere and, if necessary, different atmospheres in the process chamber 12 (humidity).

In order to introduce a specific humidity into the process chamber 12, which positively affects the transport aid, and thus, in the embodiment example, affects the ceramic filaments 20, 22, 26, 28, 30, and the operations occurring in the continuous-flow furnace 10, relative to its long-term stability, in the inlet area and indeed, in the embodiment example, in the floor area of the process chamber 12 beneath the transport path, feeds 44 provide process gases exhibiting the desired humidity, which flow into the process chamber 12 (arrow 46). In particular, the process gases contain steam, whereby the temperature will be above 100° C. This feed can also take place from the side or especially from above.

Corresponding to the representation in FIG. 2, in the region of the process-chamber outlet, a corresponding feed 48 is also provided. This is not mandatory however.

The process gas can then be exhausted, for instance, into the top region of the process chamber 12. Openings with the reference numbers 50, 52 are indicated by way of example.

Furthermore, a heating device 54 is in the top region of the process chamber 12, which can consist of resistance heating elements or a lamp, for example. If necessary, beneath the transport plane along which the wafers 14, 16, 18 are transported, a corresponding heating device is also provided in order to adjust the desired temperature to T≧500° C. in the process chamber 12.

By means of the humid process atmosphere in the process chamber 12, not only is contamination prevented from penetrating into the wafers 14, 16, 18, but at the same time the service life of the ceramic filaments 20, 22, 24, 26, 28, 30 is increased, particularly its resistance to phosphorus compounds, if phosphorus dopant sources are provided. At the same time, the advantage results that the concentration of dopant in the dopant profile of the wafers 14, 16, 18 can be better adjusted and also reduced due to the oxidation occurring in the humid atmosphere. Consequently, semiconductor elements result with high efficiency if light is to be converted into electrical energy.

1. A procedure for increasing the long-term mechanical stability of transport aids, by means of which semiconductor elements are fed for heat treatment through a process chamber in a continuous-flow process, comprising using ceramic materials as a transport aid, and exposing the ceramic materials specifically to a moist atmosphere in the process chamber open to the outside atmosphere, in which heat treatment in the process chamber is performed at a temperature T≧500° C.

2. A procedure according to claim 1, wherein the semiconductor elements are fed by a ceramic walking-filament transport system or a ceramic walking beam transport system with ceramic walking filaments or ceramic walking beams through the continuous-flow furnace.

3. A procedure according to claim 1, wherein the semiconductor elements are fed by ceramic transport rollers through the continuous-flow furnace.

4. A procedure according to claim 3, wherein the transport rollers are driven outside the continuous-flow furnace.

5. A procedure according to claim 1, wherein moisture or process gases such as steam containing moisture are fed into the process chamber to adjust the atmospheric moisture.

6. A procedure according to claim 5, wherein humidity is controlled or regulated in the process chamber.

7. A procedure according to claim 5, wherein the moisture is introduced into the process chamber by means of a process gas such as O₂, N₂, compressed air, and/or a noble gas such as argon.

8. A procedure according to claim 5, wherein the process gas transporting the moisture is introduced into the process chamber at a temperature Tₚ>100° C.

9. A procedure according to claim 1, wherein a moist process-gas atmosphere is introduced into the process chamber at a temperature Tₚ, which corresponds to that or approximately to that in an inlet region of the process chamber.

10. A procedure according to claim 1, wherein before feeding the semiconductor element through the process chamber, a dopant source is applied to an upper surface of the element.

11. A procedure according to claim 10, wherein a dopant source is used which contains phosphorus or boron.

12. A procedure according to claim 1, wherein the moisture is introduced by pyrolysis.

13. A procedure according to claim 1, wherein steam is introduced into the process chamber.

14. A procedure according to claim 1, wherein at least one process gas is passed through an aqueous liquid to absorb moisture and is then passed to the process chamber.

15. A procedure according to claim 1, wherein the atmosphere in the process chamber is adjusted and/or the process gas exhibiting the moisture is introduced such that a condensate precipitate onto the semiconductor element is avoided.

16. A procedure according to claim 1, wherein at least from an inlet side, moisture is specifically fed to the process chamber.

17. A procedure according to claim 1, wherein desired pressure ratios are set in the process chamber for specific adjustment of moisture in areas of the process chamber.

18. A procedure according to claim 1, wherein a process chamber is used which exhibits several process-gas inlet and/or exhaust points to adjust the humidity.

19. A procedure according to claim 1, wherein a process chamber is used to adjust the humidity, having a cross-section which varies in a feed direction of the semiconductor elements.

20. A procedure according to claim 1, wherein process gas leading moisture into the process chamber is fed to and exhausted from the process chamber over a width thereof, extending transversally relative to a transport direction of the semiconductor elements.

21. A procedure according to claim 20, wherein the process gas is fed to the process chamber distributed evenly over the width.

22. A procedure according to claim 20, wherein the process gas is exhausted uniformly over the width of the process chamber.

23. A procedure according to claim 1, wherein an oxygenic process gas is passed to the process chamber.

24. A procedure according to claim 1, wherein a channel region is disposed before or after an inlet and/or outlet region of the process chamber.

25. A procedure according to claim 1, wherein the process chamber with atmosphere are decoupled in fluidic aspects from the atmosphere outside the process chamber.

26. A procedure according to claim 1, wherein semiconductor elements which are used for converting light into electrical energy are fed through the process chamber.

27. A procedure according to claim 1, wherein a process gas is introduced into the process chamber by means of porous ceramic plates and/or piping.

28. A procedure according to claim 1, wherein a process gas containing moisture is fed into the process chamber in an outlet end region or outlet half of the process chamber.

29. A procedure according to claim 1, wherein 800° C. ≦T≦1100° C.

30. A procedure according to claim 29, wherein during the heat treatment, volatile components are driven from the semiconductor elements.

31. A procedure according to claim 30, wherein during the heat treatment, phosphorus compounds are driven as volatile components from the semiconductor elements.

32. A procedure according to claim 1, wherein silicon semiconductor elements are used as semiconductor elements.

33. A procedure according to claim 1, wherein during the heat treatment, a diffusion profile is produced in the semiconductor elements.

34. A procedure according to claim 33, wherein a phosphorus diffusion profile is produced.
